(19) United States
(12) Patent Application Publication
(10) Pub. No.: US 2012/0030010 A1
(43) Pub. Date: Feb. 2, 2012

(54) SOCIAL IMPACT ON ADVERTISING

(75) Inventors: Prabhakaran Krishnamoorthy, Bangalore (IN); Uday Sankar Sen, Bangalore (IN)

(73) Assignee: Yahoo! Inc., Sunnyvale, CA (US)

(21) Appl. No.: 12/845,663

(22) Filed: Jul. 28, 2010

(51) Int. Cl. G06Q 30/00; G06F 15/18

(52) U.S. Cl. 705/14.43; 705/14.41; 706/12

(57) ABSTRACT

Techniques are provided that relate to social and communications impact relating to advertising. Techniques are provided that include tracking information relating to an online advertisement served to a user, communications between the ser and one or more other users in the user's social network relating to the advertisement or a subject of the advertisement, and online or offline behavior of the other users in connection with one or more objectives of the online advertisement. The tracked information is used in assessing the impact of the advertising on the other users, which assessment can be used in advertisement campaign optimization.

### BACKGROUND

Social factors greatly influence the effectiveness and performance of advertising, including online advertising. A person naturally pays attention to, and the person's behavior can be affected by, the comments, opinions, recommendations and other communications of other people, and often particularly for those in a person's social network, which can include family, friends and peers, for example.

There is a need for techniques for recognition, application, or use of the effect of social activity or communications in connection with advertising.

### SUMMARY

Some embodiments of the invention provide systems and methods relating to social and communications impact relating to advertising. In some embodiments, techniques are provided that include tracking information relating to an online advertisement served to a user, communications between the user and one or more other users in the user's social network relating to the advertisement or a subject of the advertisement, and online or offline behavior of the other users in connection with one or more objectives of the online advertisement. The tracked information is used in assessing the impact of the advertising on the other users, which assessment can be used in advertisement campaign optimization. In some embodiments, performing the assessment includes building and use of a social impact tree, and a machine learning technique may be used in building the social impact tree.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

While the invention is described with reference to the above drawings, the drawings are intended to be illustrative, and the invention contemplates other embodiments within the spirit of the invention.

### DETAILED DESCRIPTION

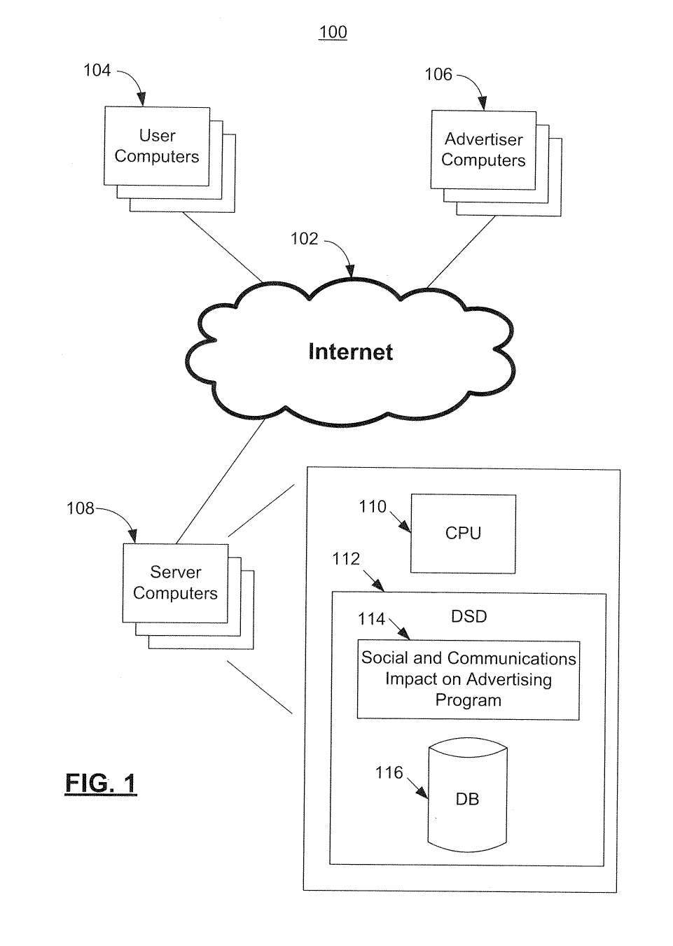

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers or other computers may be or include wireless, portable, or handheld devices such as cell phones, PDAs, etc.

Each of the one or more computers 104, 106, 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Social and Communications Impact on Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

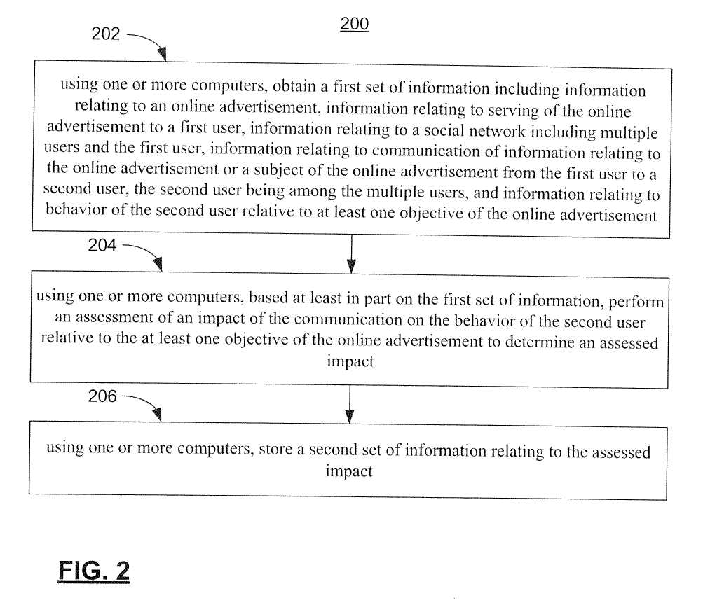

FIG. 2 is a flow diagram illustrating a method 200 according to one embodiment of the invention. At step 202, using one or more computers, a first set of information is obtained, including information relating to an online advertisement, information relating to serving of the online advertisement to a first user, information relating to a social network including multiple us s and the first user, information relating to communication of information relating to the online advertisement or a subject of the online advertisement from the first user to a second user, the second user being among the multiple users, and information relating to behavior of the second user relative to at least one objective of the online advertisement. Objectives of advertisements can broadly include any of various types of objectives. For example, objectives can include any of various desirable outcomes with regard to users, or causing or leading to such outcomes. For example, objectives could include causing desirable user conduct, behavior or action, whether offline or online, such as a click, conversion, purchase, registration, action indicated interest, etc. Objectives of advertisements could also include causing positive perception or emotion associated with the advertisement itself, or a subject of the advertisement, such as a brand or product, for example.

At step 204, using one or more computers, based at least in part on the first set of information, an assessment is performed of an impact of the communication on the behavior of the second user relative to the at least one objective of the online advertisement to determine an assessed impact.

At step 206, using one or more computers, a second set of information is stored, relating to the assessed impact.

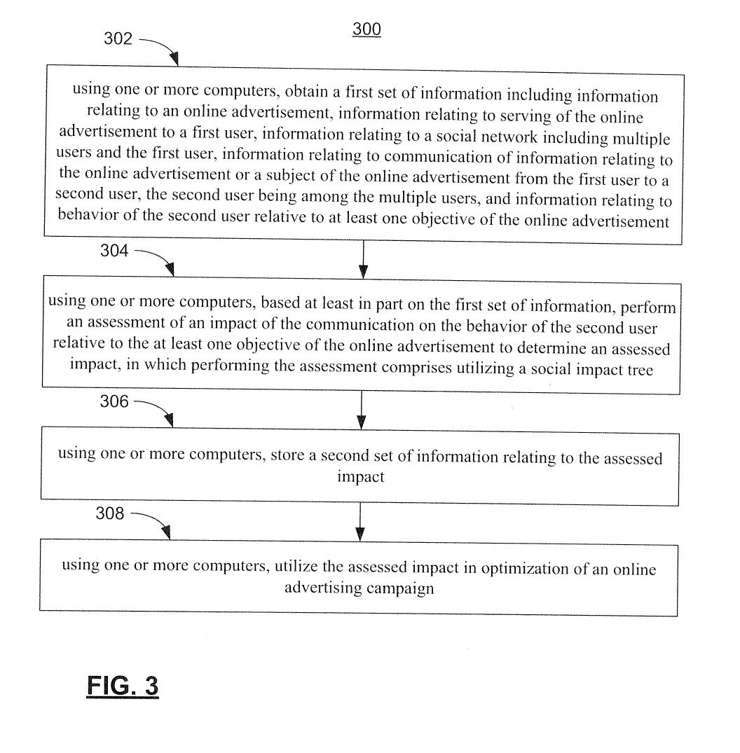

FIG. 3 is a flow diagram illustrating a method 300 according to one embodiment of the invention. Step 302 is similar to step 202 of the method 200 depicted in FIG. 2.

At step 304, using one or more computers, based at least in part on the first set of information, an assessment is performed of an impact of the communication on the behavior of the second user relative to the at least one objective of the online advertisement to determine an assessed impact, in which performing the assessment comprises utilizing a social impact tree.

At step 306, using one or more computers, a second set of information is stored, relating to the assessed impact.

At step 308, using one or more computers, the assessed impact is utilized in optimization of an online advertising campaign.

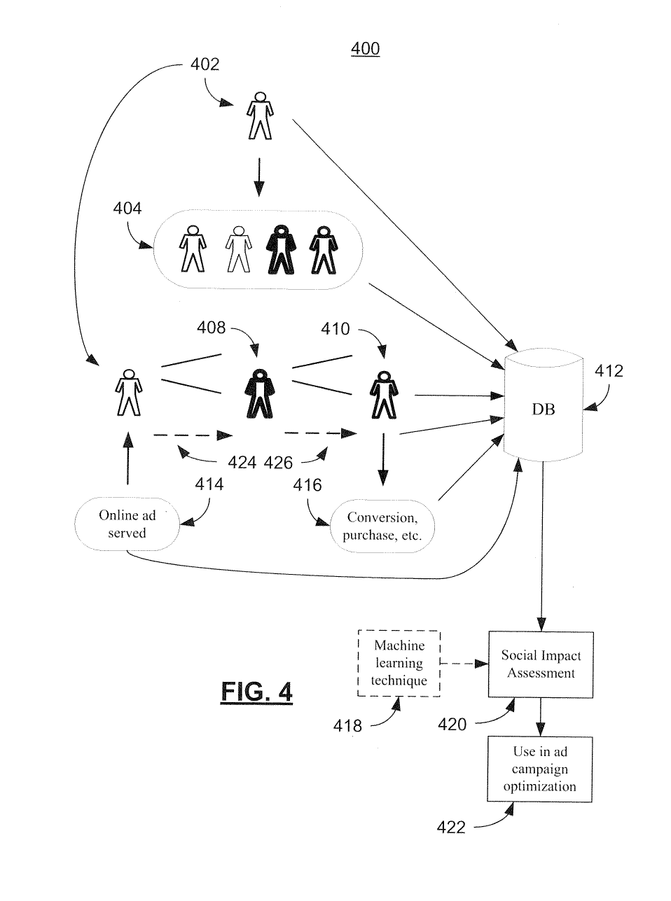

FIG. 4 is a block diagram 400 illustrating one embodiment of the invention. FIG. 402 represents a first user who is part of a social network 404. Information about the first user and the social network 404, which can include information about the individuals in the social network, relationships between individuals, distances between individuals, modes of communication between individuals, and other information, is stored in a database 412.

Block 414 represents an online advertisement served to the user 402. Information about the advertisement, such as the type of advertisement, format, text, graphics, etc., as well as information regarding the subject(u)and objective(s) of the advertisement, is stored in a database 412. Also, information regarding serving of the advertisement and the resulting impression, such as the time of serving, manner of serving, context, etc., is stored in the database 412.

Broken arrow 424 represents communication of information regarding the advertisement or a subject of the advertisement from the first user 402 to a second user 408 in the social network 404, such as a family member or a friend of the first user 402. Information regarding the communication, such as the nature of the communication, the mode of communication, the subject of the communications, circumstances surrounding the communication, whether the communication was positive or negative and to what degree, the time of the conversion, and other information, is stored in the database 412.

Information may be tracked relating to behavior of the second user 408 relative to one or more objectives of the advertisement, such as online behavior that could include Web page visits, clicks, conversions, purchases, etc., or offline behavior such as store visits, etc. Information regarding this tracked behavior is stored in the database 412.

Broken arrow 426 represents a further communication of information regarding the advertisement or a subject of the advertisement from the second user 408 to a third user 410 in the social network 404. Information regarding this communication, as well, is stored in the database 412.

Block 416 represents tracking of information relating to behavior of the third user 410 relative to one or more objectives of the advertisement, such as online behavior that could include Web page visits, clicks, conversions, purchases, etc., or offline behavior such as store visits, etc. Information regarding this tracked behavior is stored in the database 412.

It is noted that some embodiments of the invention contemplate scenarios only involving the first user 402 and the second user 408. However, the more complex scenario including the third user 410 is depicted as well, to show additional possibilities.

Block 420 represents social impact assessment, based on information including information communicated from the database 412. More particularly, block 420 represents assessment of behavior of the second user 408, or the third user 410, or both, relative to one or more objectives of the advertisement.

The assessment can include assessing the impact of the communications on the effectiveness of the advertisement, such as impact in connection with the behavior of the second user 408 in view of the communication 424 from the first user 402.

Block 422 represents use of the assessment in one or more aspects of advertising campaign optimization, such as advertisement targeting, advertisement serving, advertisement pricing or buying, etc. For example, analysis of the effect of the communications 424, 426 on the effectiveness of the advertisement relative to the behavior of the second user 408 or third user 410 can provide information regarding the value of the advertisement, the value of impressions including the advertisement in various serving scenarios, the best ways to target the advertisement to users given anticipated behavior of users hearing about the advertisement or a subject of the advertisement from other users, etc.

This type of information and assessment information can also be used in aggregate with such information for many advertisements, scenarios, etc. For example, in some embodiments, aggregated assessment information can be used in combination with machine learning models or techniques, and used to build a social impact tree, which can indicate, or be used to assess or predict, effects of communications regarding advertisements through individuals, represented as nodes in the tree, with regard to behavior of users who hear about advertisements or subjects of advertisements through one or more other users, etc. This information, in turn, can be used in advertising campaign optimization, for example.

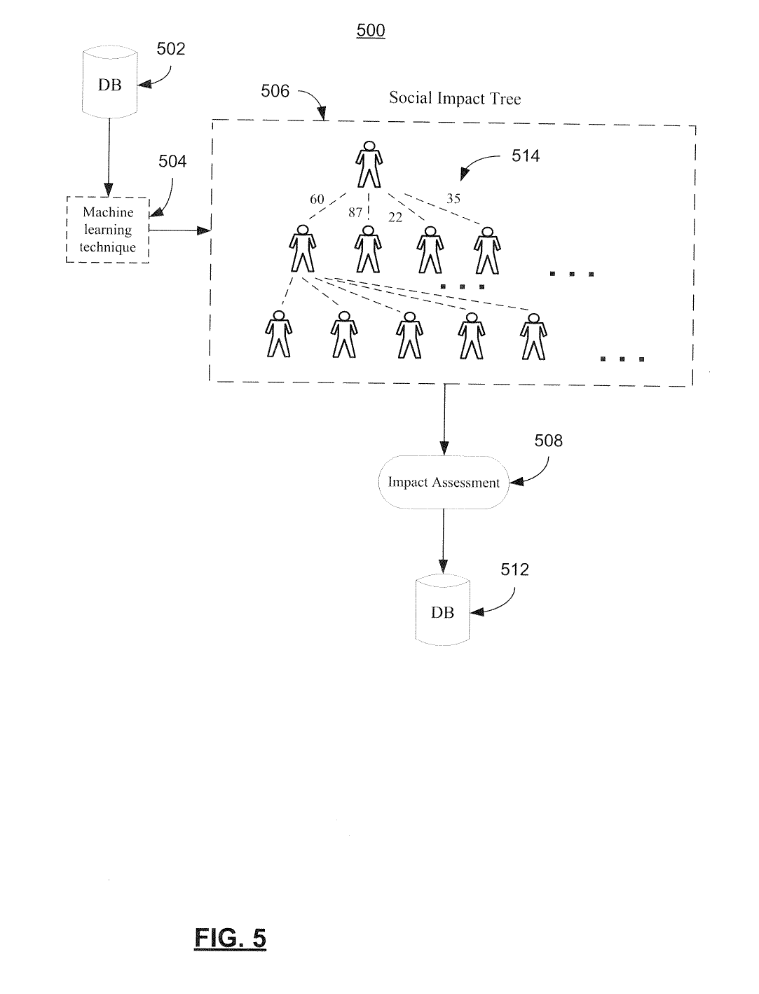

FIG. 5 is a block diagram 500 illustrating one embodiment of the invention. At block 504, one or more machine learning-based models or techniques are used in building a social impact tree 506, as discussed with regard to FIG. 4. Block 506 is a simplified, conceptual representation of a social impact tree, for illustrative purposes. As depicted, the social impact tree 506 may include links between users in a social network (only some links are depicted).

In some embodiments, a social impact tree 506 can include weighted links between users. The weighting may, for example, indicate the strength of a particular link, for purposes of assessing impact of communications according to the link on advertising. The weight of the link could indicate, for example, the strength or effectiveness of the link in terms of its impact on advertising. In some embodiments, factors taken into consideration in determining weighting could include proximity of the two users, mode of communication, etc. Various algorithms or functions could be used in utilizing the social impact tree 506, including its links, in assessing an impact on communications between users as relates to behavior of a user, who has received communications relating to the advertisement or a subject of the advertisement, with regard to one or more objectives of an advertisement. Use of the social impact tree 506 in impact assessment such as this is represented by block 508, and information regarding the determined assessment could be stored in a database 512, and could be used in various aspects of advertisement campaign optimization, for example. For example, advertising could be favored to users with higher weight to other users, or particular other users, etc.

Some embodiments of the invention provide methods and systems to measure and utilize social, or “word-of-mouth” (broadly including more than just oral communications) impact on advertising and fulfillment of advertising objectives, such as brand engagement, purchases, return on investment on advertising spend, increased advertisement performance, etc. For example, if a person who views an advertisement mentions the advertisement or associated product, service or brand to a family member or friend, especially in a positive light, this may influence the family member or friend to go to Web page about the product or purchase the product, for example.

Some embodiments recognize and address the fact that it is difficult to measure such things as deeply or positively an advertisement is etched into a viewers mind so that the viewer influences others in his social network regarding the advertisement or a subject of the advertisement, how long the viewer will retain and be likely communicate information about the advertisement, etc.

Some embodiments of the invention utilize controlled experimentation. As just one of many possible example or arrangements, multiple sets of similarly or identically targeted users can be identified, with similar or identical network structures, such as if each set includes only family members, etc. For each of a first group, or experimental group, of sets, a particular advertisement is shown to a particular user in the set, called the main user, but not other users in the set. For each of a second group, or control group, of sets, the particular advertisement is purposely not shown to a particular user, or main user, or the other users in the set. Tracking behavior over time of the users, other than the main users, in each of the experimental and control group (as well as other associated information and details) and then comparing the two, can facilitate assessment of the social or communications impact on advertising. Furthermore, machine learning can be used along with experimental results in developing social impact trees for networks for which experimental information is not available.

In some embodiments, in a controlled experiment, a first user could be contacted to obtain, from the first user, information regarding who the user communicated with about the advertisement, the nature of the communication, etc. Furthermore, in some embodiments, in a controlled experiment, a second user, who has been communicated with by a first user regarding an advertisement, could be contacted to obtain, from the second user, information regarding the nature of the communication, etc.

Furthermore, in some embodiments, both online and offline behavior is tracked. For example, offline store visits, purchases, or other offline actions can be tracked, as well as online Web site visits, clicks, conversions, communications with the advertiser such as chats or calls, store visits including inquiries about the product, other actions, etc.

Furthermore, in some embodiments, scores can be assigned to main users. The scores can indicate how effective a particular user is in influencing other users. Users with higher scores could be preferred as targets of advertising, etc.

Controlled experimentation can also be used in analyzing factors such as how much time must pass before an advertisement has the most effect in terms of social impact (such as how much the user will effectively communicate to other uses about the advertisement, etc.), how many times the advertisement must be shown to a user to have the greatest social impact effect, etc. This information could be used in advertising campaign optimization, such as in determining an optimal timing and number of impressions to show a user to obtain the greatest social impact, etc. Still further, such information can be determined for different modes of communication, such as phone, instant messaging, etc., to determine the differences between them.

Various refinements and degrees of granularity are possible with controlled experimentation. For example, subgroups can be created for different categories of main users, such as, for example, by profession, demographics, or other targeting categories. Social impact can be assessed for each group to determine differences between them in this regard.

Various techniques can be used in exploring and determining social networks and social graphing. For example, connected persons could be determining using information from social networking or similar sites, such as Linkedin, Facebook or Twitter. Furthermore, email and other electronic message exchange information could be utilized, including tracking number, frequency and nature of messaging in determining relationships or degree of connection, etc. Also, phone call information could be utilized, including Internet calls, land line calls and mobile calls. Still further, conditional relations could be determined. For example, if a user posts advertisement elated information to a public blogging site, then followers of the blog could be added to a social graph as a conditional relation, and such links could be added dynamically.

As mentioned, mode of communication is considered in embodiments of the invention, including in building and utilizing social impact trees in impact assessment. For example, the effect or impact of physical or geographic distance could be determined, including how the mode of communication, such as phone, email, chat, blog, etc., is influenced by the distance.

As mentioned, techniques according to embodiments of the invention can be used in any of various aspects of advertising optimization and advertising campaign optimization, and could also be used by other parties, such as in online advertising or auction-based online advertising marketplace facilitators, in optimizing aspects of the marketplace. This can include optimization with regard to targeting, serving, bidding, pricing, etc. As a further example, information obtained from embodiments of the invention can be used in optimization aspects relating to timing and frequency of advertising, such as in determining frequency minimums or caps per user, or length of intervals between impressions, etc. For example, suppose that a user accepts an invite to play a video game at a certain time. It may be predicted that the user is most likely to influence his or her friends a certain amount of time later, such as two to three hours later, when the user may be likely to be playing the game with his or her friends. This may present an optimal window for targeting, considering social impact.

Furthermore, some embodiments include targeting certain individuals primarily to influence behavior of other individuals. For example, a parent may typically make purchases, but the son or daughter may be most impressed by a video game advertisement. The son or daughter may be targeted, give that he or she may socially influence his or her parent to purchase a video game, for instance.

Still further, in some embodiments, searching and search queries can be analyzed and utilized. For example, a search for a video game may present an opportunity to target the searcher, even if the objective or partial objective is to cause the searcher to socially influence another person to make a purchase. A social impact tree, for example, can be used in this and other regards.

Some embodiments of the invention can be used in combination with advertisements that include social elements. For example, in some embodiments, advertisements are utilized that include review, comment, or purchase-related information, whether online or offline. For example, such information from a first user can be added to or incorporated in or as an advertisement served to a second user in a social network of the first user. The added information may induce the second user to behave in a desired way, such as by making an online or offline purchase, for example. In some embodiments, such online or offline behavior is tracked, and benefit is provided to the first user for providing or agreeing to use of the review, comment, or purchase information, for example. Some embodiments include use of, or are used with, such advertisements and arrangements. For example, social graph and social impact tree information can be used in optimizing such advertising, including targeting, users to link, etc. Furthermore, online and offline tracking, such as of purchases, conversions, etc., can be used in, for example, assessing benefit due to the first user, as well as in various other ways, such as feedback to refine a social impact tree, etc. Embodiments of the invention contemplate such combinations and complementary use of various determined and tracked information.

While the invention is described with reference to the above drawings, the drawings are intended to be illustrative, and the invention contemplates other embodiments within the spirit of the invention.

1. A method comprising:
using one or more computers, obtaining a first set of information comprising:
information relating to an online advertisement;
information relating to serving of the online advertisement to a first user;
information relating to a social network including multiple users and the first user;
information relating to communication of information relating to the online advertisement or a subject of the online advertisement from the first user to a second user, the second user being among the multiple users; and
information relating to behavior of the second user relative to at least one objective of the online advertisement;
using one or more computers, based at least in part on the first set of information, performing an assessment of an impact of the communication on the behavior of the second user relative to the at least one objective of the online advertisement to determine an assessed impact; and
using one or more computers, storing a second set of information relating to the assessed impact.

2. The method of claim 1, wherein performing the assessment comprises using controlled experimentation.

3. The method of claim 1, comprising utilizing the assessment in optimization of an advertising campaign.

4. The method of claim 1, comprising utilizing the assessment in determining a value of one or more online advertisements.

5. The method of claim 1, wherein obtaining information relating to behavior of the second user relative to at least one objective of the online advertisement comprises tracking online activities of the second user.

6. The method of claim 1, wherein obtaining information relating to behavior of the second user relative to at least one objective of the online advertisement comprises tracking conversions of the second user.

7. The method of claim 1, wherein obtaining information relating to behavior of the second user relative to at least one objective of the online advertisement comprises tracking offline activities of the second user.

8. The method of claim 1, wherein obtaining information relating to behavior of the second user relative to at least one objective of the online advertisement comprises tracking offline purchases of the second user.

9. The method of claim 1, comprising building and utilizing a social impact tree.

10. The method of claim 1, comprising building and utilizing a social impact tree, and wherein building the social impact tree comprises utilizing at least one machine learning technique.

11. The method of claim 1, comprising building and utilizing a social impact tree, and comprising utilizing the social impact tree in assessing value of advertisements based at least in part on social impact factors.

12. The method of claim 1, herein obtaining information relating to an online advertisement comprises obtaining information identifying the online advertisement.

13. The method of claim 1, wherein obtaining information relating to serving of the online advertisement to a first user comprises obtaining information indicating the time of serving.

14. The method of claim 1, wherein obtaining information relating to communication of information relating to the advertisement or a subject of the advertisement from the first user to a second user comprises obtaining information relating to a mode of the communication.

15. The method of claim 1, wherein storing a second set of information relating to the assessed impact comprises storing information indicating the assessed impact.

16. The method of claim 1, wherein performing the assessment comprises using controlled experimentation, and wherein the controlled experiment comprises contacting the first user and inquiring with the first user as to any communications the first user has made associated with the advertisement, including what other users the first user has communicated with and natures of the communications.

17. The method of claim 1, wherein performing the assessment comprises using controlled experimentation, and wherein the controlled experiment comprises contacting the second user and inquiring with the second user as to any communications the second user has received associated with the advertisement, including what other users have communicated to the second user and natures of the communications.

18. A system comprising:
one or more server computers coupled to a network; and
one or more databases coupled to the one or more server computers;
wherein the one or more server computers are for:
obtaining a first set of information comprising:
information relating to an online advertisement;
information relating to serving of the online advertisement to a first user;
information relating to a social network including multiple users and the first user;
information relating to communication of information relating to the online advertisement or a subject of the online advertisement from the first user to a second user, the second user being among the multiple users; and
information relating to behavior of the second user relative to at least one objective of the online advertisement;
based at least in part on the first set of information, performing an assessment of an impact of the communication on the behavior of the second user relative to the at least one objective of the online advertisement to determine an assessed impact; and
storing a second set of information relating to the assessed impact in a east one of the one or more databases.

19. The system of claim 18, wherein the one or more server computers are coupled to the Internet.

20. The system of claim 18, comprising building and utilizing a social impact tree.

21. The system of claim 18, comprising building and utilizing a social impact tree, and comprising building the social impact tree utilizing a machine learning technique.

22. A computer readable medium or media containing instructions for executing a method comprising:
using one or more computers, obtaining a first set of information comprising:
information relating to an online advertisement;
information relating to serving of the online advertisement to a first user;
information relating to a social network including multiple users and the first user;
information relating to communication of information relating to the online advertisement or a subject of the online advertisement from the first user to a second user, the second user being among the multiple users; and
information relating to behavior of the second user relative to at least one objective of the online advertisement;
using one or more computers, based at least in part on the first set of information, performing an assessment of an impact of the communication on the behavior of the second user relative to the at least one objective of the online advertisement to determine an assessed impact, wherein performing the assessment comprises utilizing a social impact tree;
using one or more computers, storing a second set of information relating to the assessed impact; and
using one or more computers, utilizing the assessed impact in optimization of an online advertising campaign.
